(19) United States
(12) Patent Application Publication
(10) Pub. No.: US 2023/0378825 A1
(43) Pub. Date: Nov. 23, 2023

(54) Electric Machine and Installation

(71) Applicant: Siemens Aktiengesellschaft, München (DE)

(72) Inventors: Carsten Schuh, Baldham (DE); Thomas Soller, Deggendorf, Bayern (DE); Rolf Vollmer, Gersfeld (DE)

(73) Assignee: Siemens Aktiengesellschaft, München (DE)

(21) Appl. No.: 18/247,145

(22) PCT Filed: Sep. 21, 2021
(86) PCT No.: PCT/EP2021/075905

§ 371 Date: Mar. 29, 2023

(30) Foreign Application Priority Data
Sep. 30, 2020 (EP) 20199239.3

(51) Int. Cl. H02K 1/02; H02K 1/04

(52) U.S. Cl. CPC H02K 1/02; H02K 1/04; H02K 2201/09

(57) ABSTRACT

Various embodiments of the teachings herein include an electric machine. The machine comprises a stator and/or a rotor with a stack of soft-magnetic laminations. The soft-magnetic laminations are disposed next to one another on flat sides of the laminations. At least one of the flat sides on which two adjacent laminations are close to one another is formed with a sintering skin.

### CROSS-REFERENCE TO RELATED APPLICATIONS

This application is a U.S. National Stage Application of International Application No. PCT/EP2021/075905 filed Sep. 21, 2021, which designates the United States of America, and claims priority to EP Application No. 20199239.3 filed Sep. 30, 2020, the contents of which are hereby incorporated by reference in their entirety.

### TECHNICAL FIELD

The present disclosure relates to electric machines. Various embodiments include electric machines with a rotor and/or stator, having a stack of soft-magnetic laminations, and/or installations with an electric machine.

### BACKGROUND

It is known to form electric machines with rotors and/or stators which are in each case formed by stacks of soft-magnetic laminations. Such stacks of soft-magnetic laminations must be laboriously assembled and electrically insulated, in order that no eddy currents or voltage flashovers occur during the operation of the electric motors.

### SUMMARY

The teachings of the present disclosure provide an improved electric machine with a rotor and/or stator with a stack of soft-magnetic laminations in which an assembly and/or an electrical insulation of the soft-magnetic laminations can be realized at low cost and with little effort. Moreover, it is intended that the electric machine can be manufactured by novel manufacturing processes for producing the soft-magnetic laminations.

As an example, some embodiments of the present disclosure include an electric machine with a stator (80) and/or a rotor with a stack (10) of soft-magnetic laminations (20), which are close to one another on flat sides (30, 50) of the laminations (20), in which at least one of the flat sides (50) on which two adjacent laminations are close to one another is formed with a sintering skin (55).

In some embodiments, the laminations (20) are or comprise screen-printed and/or stencil-printed parts.

In some embodiments, the sintering skin (55) is an as-fired sintering skin.

In some embodiments, the sintering skin (55) is formed by one or more metal oxides and/or metal nitrides and/or metal carbides and/or metal silicides.

In some embodiments, the electric machine includes at least one adhesive layer which connects together laminations of the stack that are close to one another, the adhesive layer being arranged in each case on the or a sintering skin.

In some embodiments, the electric machine includes at least one insulating layer (75) which electrically insulates laminations (20) of the stack (10) that are close to one another from one another, the insulating layer (75) being arranged in each case on the or a sintering skin (55).

In some embodiments, the laminations (20) each have a first (30) and a second flat side (50), the laminations (20) tapering from the first (30) to the second flat side (50) and the first flat sides (30) of the laminations (20) of the stack (10) facing in the same direction.

In some embodiments, the laminations (20) each have a first (30) and a second flat side (50), at least the second flat side (50) being formed in each case with a sintering skin (55) and the laminations (20) facing in the same direction with their second flat side (50).

In some embodiments, the laminations (20) have a sintering skin (55) in each case on the first (30) and second flat side (50).

As another example, some embodiments include an installation and/or a vehicle with an electric machine (110) as described herein.

### BRIEF DESCRIPTION OF THE DRAWINGS

The teachings of the present disclosure are explained in more detail below on the basis of an exemplary embodiment that is represented in the drawing, in which:

FIG. 1 shows a stack of soft-magnetic laminations of a stator of an electric machine incorporating teachings of the present disclosure schematically in cross section; and

FIG. 2 shows an industrial installation with a drive with a electric machine incorporating teachings of the present disclosure with the stator with the stack of soft-magnetic laminations according to FIG. 1 schematically in a basic diagram.

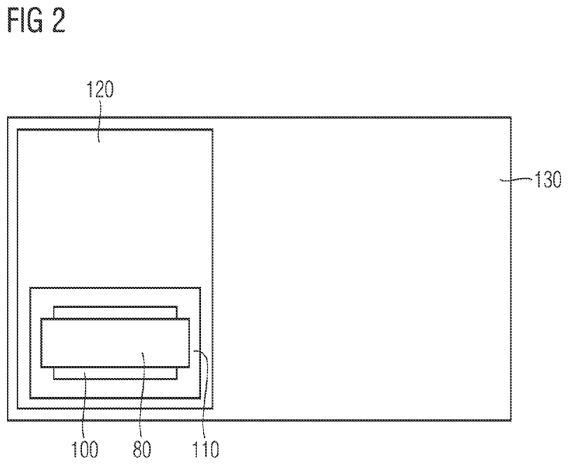

### DETAILED DESCRIPTION

Some electric machines incorporating teachings of the present disclosure include a stator and/or a rotor with a stack of soft-magnetic laminations. The soft-magnetic laminations of the electric machine are close to one another on flat sides of the laminations, at least one of the flat sides on which two adjacent laminations are close to one another being formed with a sintering skin.

In this case, the expression “a flat side is formed with a sintering skin” means that “a sintering skin forms at least part of a flat side”. Consequently, some embodiments of an electric machine have a stator and/or a rotor with a stack of soft-magnetic laminations, the soft-magnetic laminations of the electric machine being close to one another on flat sides of the laminations and at least one sintering skin forming at least part of at least one of the flat sides on which two adjacent laminations are close to one another. Expediently, a sintering skin in each case forms at least part of in each case at least one of the flat sides on which two adjacent laminations are close to one another. In some embodiments, the sintering skin in each case forms the entire flat side.

The sintering skin permits homogeneous and uniform wetting of the sintering skin and consequently also of the flat sides of the laminations of the electric machine. Consequently, the laminations of the stack of the electric machine according to the invention can be wetted with an insulation layer and/or an adhesive layer. As a result of the improved wettability of the laminations, the electric machine can be provided with a homogeneous and uniform insulation layer and/or adhesive layer, the electrical power capacity of the electric machine being able to be particularly great compared with the prior art.

“Laminations” in the sense of the present disclosure may also mean printed and/or sintered parts. In the context of the present disclosure, the term “lamination” could also be replaced by the expression “material layer or material layer structure”, the material layer or the material layer structure being a flat part. In other words, the term “lamination” does not necessarily imply that the “lamination” is produced by means of rolling. Such a “lamination”, in particular when it has a flat side formed with a sintering skin, may be formed by means of sintering, by means of printing and subsequent sintering.

In some embodiments, a sintering skin can be easily formed with isotropically oriented, i.e. not textured, grain sizes with diameters expediently between 10 and 500 micrometers, the sintering skin having an average roughness of between 0.2 micrometers and 5 micrometers. Especially in the case of a surface formed with a sintering skin, very flat grain surfaces without specific peaks protruding from the grain and, on the surface, sunken grain boundaries with rounded flanks can be realized. A sintering skin can be formed variously in the region of a surface facing a carrier substrate during printing, to provide a flat side facing away from the carrier substrate during printing or an edge area continuing from the carrier substrate. Consequently, the laminations can be formed with flat sides with different colors and/or reflections and/or surface structures. In this way, flat sides of the laminations can be easily distinguished visually, and so an arrangement of the laminations into a stack can be accomplished particularly easily and preferably can be automated.

In some embodiments, the laminations are screen-printed and/or stencil-printed parts or comprise screen-printed and/or stencil-printed parts. The laminations are such screen-printed and/or stencil-printed parts, in which the laminations are printed by means of a printing paste formed by metal powder and are subsequently sintered. In this way, a geometrical shape of the laminations can be realized particularly easily by means of stencil printing, and so there is no need for subtractive machining steps for manufacturing the electric machine according to the invention. The laminations have no induced mechanical stresses as a result of shaping processes, such as in particular rolling or stamping processes, for which reason the soft-magnetic properties of the soft-magnetic laminations can be retained unimpaired.

In some embodiments, the sintering skin is an as-fired sintering skin.

In some embodiments, the sintering skin is formed by one or more metal oxides and/or metal nitrides and/or metal carbides and/or metal silicides or a combination of one or more of the aforementioned materials. In some embodiments, the sintering skin also comprises adjuvants, which are for instance eutectics-forming or liquid-phase-forming. In this way, the sintering skin on the grain surfaces can be formed with mixed crystals, and so characteristic surface energies and/or wetting angles of the laminations are influenced with regard to a more homogenous and more uniform wettability.

In some embodiments, said electric machine has at least one adhesive layer which connects together laminations of the stack that are close to one another, the adhesive layer preferably being arranged in each case on the sintering skin. In this development, the laminations of the stack are adhesively connected to one another, it being possible as a result of the improved wettability of the soft-magnetic laminations with the adhesive layer to simultaneously achieve a particularly high electrical power capacity of the electric machine.

In some embodiments, the electric machine has at least one insulating layer which electrically insulates laminations of the stack that are close to one another from one another, the insulating layer being arranged in each case on the or a sintering skin. The laminations of the stack are electrically insulated in relation to one another in a reliable manner, it being possible as a result of the improved wettability of the soft-magnetic laminations with the insulating layer to simultaneously achieve a particularly high electrical power capacity of an electric machine realized with the stack.

In some embodiments, the laminations each have a first and a second flat side, the laminations tapering from the first to the second flat side and the first flat sides of the laminations of the stack facing in the same direction. In this way, the flat sides of the laminations can be distinguished from one another, and so, in particular in the case of laminations in which just one of two flat sides is formed with metal oxide, the side formed with metal oxide can be easily identified on the basis of the geometrical shape.

In some embodiments, the laminations each have a first and a second flat side, at least the second flat side being formed in each case with a sintering skin and the laminations facing in the same direction with their second flat side. In this way, all of the laminations or all of the laminations apart from one or two peripheral laminations of the stack can be formed in an identical way. Consequently, almost all of the laminations can be manufactured in an identical way. Consequently, manufacturing of the electric machine can be performed in a cost-effective manner without deviations or required manual interventions.

In some embodiments, the laminations have a sintering skin in each case on the first and second flat side.

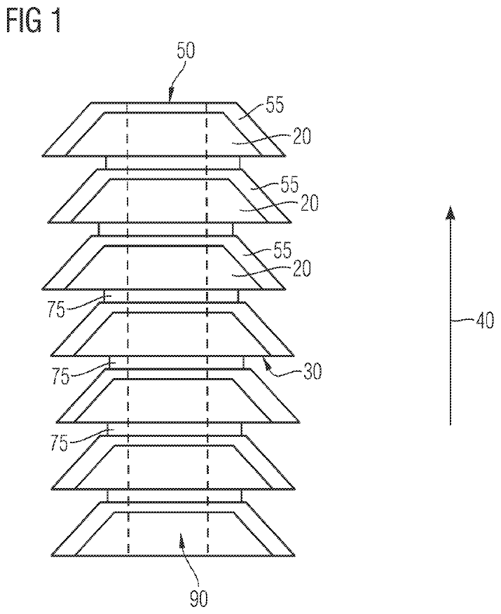

The stack 10 shown in FIG. 1 is formed by soft-magnetic laminations 20 and forms a stator of an electric machine incorporating teachings of the present disclosure in the form of an electric motor. The soft-magnetic laminations 20 of the stack 10 are manufactured by means of screen and stencil printing of a metal paste of soft-magnetic metal, for example pure iron, and in each case have externally the form of a truncated cone with a circular base area 30. In addition, the externally frustoconical soft-magnetic laminations 20 are provided with a central lead-through, in which there is a rotor of the electric machine.

The soft-magnetic and externally frustoconical laminations 20 in each case taper in a stacking direction 40 from the base area 30 to an end face 50, which has a smaller outer diameter in comparison with the base area 30 and is parallel to the base area. The end faces 50 of the soft-magnetic laminations 20 are formed by a sintering skin 55, here an as-fired sintering skin, of the soft-magnetic laminations 20. In the embodiment shown, the sintering skin 55 is caused by the manufacturing process and is not removed after manufacture, but is left on the soft-magnetic laminations 20 before the soft-magnetic laminations 20 are joined together to form a stack. In the embodiment shown, the sintering skin 55 is formed by metal oxide, here pure iron oxide. In some embodiments, the sintering skin 55 may be formed by one or more metal nitrides and/or one or more metal carbides and/or one or more metal silicides.

The frustoconical form and the sintering skin 55 of the soft-magnetic laminations 20 are realized by means of the soft-magnetic laminations 20 being manufactured by screen and stencil printing: the soft-magnetic laminations 20 are printed by means of a stencil with an annular hole onto a substrate as circular-cylindrical green blanks with an inner circular-cylindrical lead-through. The substrate is in each case formed with such a high surface roughness that, at its bearing surface on the substrate that forms the later base area 30 of the later soft-magnetic lamination 20, the green blank cannot follow a sintering shrinkage occurring during subsequent sintering of the green blank. The green blank is subsequently sintered. Consequently, the green blank shrinks to a greater extent away from the bearing surface than at the bearing surface, at which the sintering shrinkage even disappears completely on account of the surface roughness. As a result of the locally different sintering shrinkage, an end face of the green blank that forms the later end face 50 of the soft-magnetic lamination 20 is reduced in its diameter as compared with the bearing surface, and so, during the sintering, the green blank adopts an external frustoconical form (internally, the originally cylindrical lead-through likewise adopts a frustoconical form).

At the end face 50 of the soft-magnetic lamination 20, the sintering skin 55 takes the form of an as-fired sintering skin during the sintering. As a result of the sintering of the green blank on the substrate and as a result of the chosen process conditions, the as-fired sintering skin only forms on the surface of the soft-magnetic laminations 20 that is facing away from the substrate. In this way, the end face 50 of the soft-magnetic laminations 20 is in each case formed by the sintering skin 55. Correspondingly, after the sintering, the soft-magnetic laminations 20 can be arranged oriented in the same way with their end face 50, and consequently with their sintering skin 55, and so respectively adjacent soft-magnetic laminations 20 are close to one another at a sintering skin 55.

After the sintering, the sintered soft-magnetic lamination 20 is detached from the substrate and connected to further soft-magnetic laminations 20 manufactured in the same way to form the stack 10. As already mentioned above, the soft-magnetic laminations 20 are in this case connected to one another in such a way that the base areas 30 of the soft-magnetic laminations 20 in each case face in the same direction (here opposite to the stacking direction 40). The end faces 50 of the soft-magnetic laminations 20 of the stack 10 correspondingly face in the stacking direction 40. The soft-magnetic laminations 20 are in this case joined to one another with an intermediate adhesive layer 75. The adhesive layer 75 is applied to the sintering skin 55 of the laminations 20 in the liquid state, whereupon the adhesive layer 75 is distributed with a homogeneous thickness uniformly on the sintering skin 55. In some embodiments, as an alternative or in addition to the adhesive layer 75, an insulating layer is present between the laminations 20, said insulating layer likewise being able to wet the sintering skin 55 in the liquid state.

In some embodiments, the soft-magnetic laminations 20 may also be formed with a different geometrical shape, for instance as mathematical cylinders with an annular base area, either one end face or both end faces facing away from one another and the lateral surfaces being formed with a sintering skin. The forming of the end faces and lateral surfaces with a sintering skin can be achieved for example by means of a corresponding adaptation of the parameters of the sintering process and also by means of a suitable sintering substrate.

The stack 10 of soft-magnetic laminations 20 is held in a stack mount (not explicitly shown). The stack mount is electrically insulated from the stack 10 by means of an insulation in the form of an insulating paper (not explicitly shown). In some embodiments, the frustoconical form may already be provided during the printing of the green blanks of the soft-magnetic laminations 20, and so a sintering as described above encourages the formation of the frustoconical form, but does not cause it on its own. As an alternative or in addition, the external frustoconical form may also be predetermined exclusively by a 3D printing of the green blank, and so there is no need for a surface roughness of the substrate as described above.

The stack 10 forms with the insulating paper and the stack mount a stator 80 of an electric machine 100 incorporating teachings of the present disclosure. For this purpose, the lead-throughs of the laminations 20 form in the stack 10 a central lead-through 90, leading in the stacking direction 40. In the embodiment shown, the lead-through is in each case provided during the printing of the soft-magnetic laminations 20, by the laminations 20 being printed as circular rings. In some embodiments, the lead-through 90 may also be subsequently provided subtractively, for example by means of milling.

For forming an electric machine 90, a rotor 100, which can be manufactured in the same way as the stator 80, with the exception of the lead-through 90 and also the stack mount and the insulating paper, which are not needed for a rotor 100, is introduced into the lead-through of the stator 80. For forming an electric machine 100, the stator 80 is provided in a way with coils and an electrical feed for the coils.

In the embodiment shown, the electric machine 110 is an electric motor and part of a drive 120 of an industrial installation 130, here a conveyor belt installation. In some embodiments, the electric machine incorporating teachings of the present disclosure is an electric motor and part of a drive of an autonomous warehouse vehicle or an electric generator of an energy converter device of an energy generating installation, for example a wind turbine.

What is claimed is:

1. An electric machine comprising:
a stator and/or a rotor with a stack of soft-magnetic laminations;
wherein the soft-magnetic laminations are disposed next to one another on flat sides of the soft-magnetic laminations;
wherein at least one of the flat sides on which two adjacent laminations are close to one another is formed with a sintering skin.

2. The electric machine as claimed in claim 1, wherein the soft-magnetic laminations comprise screen-printed and/or stencil-printed parts.

3. The electric machine as claimed in claim 2, wherein the sintering skin comprises an as-fired sintering skin.

4. The electric machine as claimed in claim 1, wherein the sintering skin comprises one or more metal oxides and/or metal nitrides and/or metal carbides and/or metal silicides.

5. The electric machine as claimed in claim 1, further comprising an adhesive layer connecting laminations of the stack to one another, wherein the adhesive layer is arranged on the sintering skin.

6. The electric machine as claimed in claim 1, further comprising an insulating layer electrically insulates laminations of the stack from one another;
wherein the insulating layer is arranged on the or a sintering skin.

7. The electric machine as claimed in claim 1, wherein:
the soft-magnetic laminations each have a first flat side and a second flat side;
the soft-magnetic laminations each taper from the respective first flat side to the second flat side; and
the first flat sides of each of the soft-magnetic laminations face in a shared direction.

8. The electric machine as claimed in claim 1, wherein:
The soft-magnetic laminations each have a first flat side and a second flat side;
the second flat side comprises a sintering skin; and
the second flat side of each of the soft-magnetic laminations faces in a shared direction.

9. The electric machine as claimed in claim 1, wherein the soft-magnetic laminations each have a sintering skin on both a respective first flat side and a respective second flat side.

10. (canceled)
